(19) United States
(12) Patent Application Publication
(10) Pub. No.: US 2018/0320721 A1
(43) Pub. Date: Nov. 8, 2018

(54) APPARATUS TO CONNECT A VALVE STEM TO AN ACTUATOR

(71) Applicant: FISHER CONTROLS INTERNATIONAL LLC, Marshalltown, IA (US)

(72) Inventors: Michael Wildie McCarty, Marshalltown, IA (US); Douglas Paul Gethmann, Gladbrook, IA (US); Kyle Anthony Hausladen, Marshalltown, IA (US); Jason Kyle Reuther, Grundy Center, IA (US)

(21) Appl. No.: 15/586,520

(22) Filed: May 4, 2017

(51) Int. Cl. F16B 7/04; F16K 31/00

(52) U.S. Cl. CPC F16B 7/0426; F16K 31/00

(57) ABSTRACT

Apparatus to connect a valve stem to an actuator are described herein. An example apparatus includes a valve stem connector including a first portion and a second portion, a hinge to operatively couple the first and second portions, and a fastener operatively coupled to the first portion to secure the first and second portions in a closed position

### FIELD OF THE DISCLOSURE

This disclosure relates generally to stem connectors, and, more particularly, to apparatus to connect a valve stem to an actuator.

### BACKGROUND

Actuators are connected to valve stems of a valve to operate the valve (e.g., open, close). Valve stems are typically connected to actuator stems using a valve stem connector. In some implementations, the valve stem connectors are threadably coupled to the valve stem and/or the actuator stem. Alternatively, adapters may be threadably coupled to the valve stem and/or the actuator stem to facilitate connection of the valve stem and actuator stem using a valve stem connector.

### SUMMARY

An example apparatus includes a valve stem connector including a first portion and a second portion, a hinge to operatively couple the first and second portions, and a fastener operatively coupled to the first portion to secure the first and second portions in a closed position.

Another example apparatus includes a stem connector having a first portion and a second portion, wherein the first and second portions are rotatably coupled via a hinge and secured via a fastener.

Yet another example apparatus includes means for connecting a first stem and a second stem, the means for connecting including a first portion and a second portion, means for coupling the first portion to the second portion, and means for securing the means for connecting in a first position, the means for securing operatively coupled to the means for connecting.

An example method includes opening a valve stem connector by rotating a first portion and a second portion of the valve stem connector about a hinge, closing the valve stem connector around an end of a valve stem and an end of an actuator stem, and moving a fastener to a secured position to securely couple the end of the valve stem and the end of the actuator stem via the valve stem connector.

### BRIEF DESCRIPTION OF THE DRAWINGS

FIG. 1 is an example environment in which an example apparatus described herein may be implemented.

FIGS. 2A and 2B depict an example implementation the example apparatus described herein.

FIGS. 3A and 3B depict another example implementation the example apparatus described herein.

FIGS. 4A and 4B depict yet another example implementation the example apparatus described herein.

The figures are not to scale. Wherever possible, the same reference numbers will be used throughout the drawing(s) and accompanying written description to refer to the same or like parts. As used in this patent, stating that any part is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

To enable operation of a valve by an actuator, a valve stem may be coupled to an actuator stem using a valve stem connector. In some examples, the valve stem may be threadably coupled to the actuator stem. In some examples, simply threadably coupling the valve stem to the actuator stem is not sufficient to securely couple the valve stem and the actuator stem. For example, vibrations due to operation of the actuator and/or the valve may loosen the threaded coupling between the valve stem and the actuator stem. Thus, the valve stem connector facilitates a secure connection between the valve stem and the actuator stem.

Valve stem connectors are operative to connect a valve stem to an actuator and/or an actuator stem. The connectors may be threadably coupled to the respective valve stem and/or the actuator stem. Some valve stems and/or actuator stems include adapters to enable the valve stem connector to be connected to and disconnected from the valve stem and/or the actuator stem. In examples in which adapters are coupled to the valve stem and/or the actuator stem, the valve stem connector may be two pieces (e.g., plates, halves, portions, etc.) connected using at least two fasteners (e.g., screws, bolts). The fasteners are disposed through threaded holes in each of the pieces. For example, one threaded hole may be disposed on either side of the openings through which the valve stem and the actuator stem pass. These valve stem connectors are often difficult to attach to the valve stem and actuator stem because the threaded holes must be aligned to couple the two pieces together. This tedious task can be time consuming and may result in lost operational time of the valve.

The example valve stem connectors disclosed herein enable quick attachment to the valve stem and the actuator stem, and can be attached to the valve stem manually (e.g., by hand, without the use of tools). The example valve stem connectors are a single assembly and may be quickly connected and disconnected, which substantially reduces loss of valve operating time. An example apparatus described herein includes a valve stem connector having a first portion and a second portion. A hinge of the valve stem connector operatively couples the first and second portions. A fastener is coupled to the first portion to secure the first and second portions in a closed position (e.g., to secure the valve stem connector around a valve stem and an actuator stem). In some examples, the hinge is positioned at respective first ends of the first and second portions to pivotably or rotatably couple the first ends. Thus the first and second portions are able to rotate about the hinge relative to each other. When the valve stem connector is in a closed position, the first and second portions form a cavity (e.g., an aperture). The cavity includes a first opening and a second opening opposite the first opening. The first opening receives an end of a valve stem and the second opening receives an end of an actuator stem.

The example valve connector may include a pin disposed in a second aperture of a second end of the first portion. The pin operatively couples the fastener to the first portion to enable the fastener to rotate relative to the first portion. A second end of the second portion includes a groove to receive a portion of the fastener when the valve stem connector is in the closed position. The fastener may include a stop to contact the second portion adjacent to the groove to secure the first and second portions in the closed position. In some examples, the fastener includes a rod that is at least partially threaded. A nut is threadably coupled to the rod. The nut adjusts a force the fastener applies to the first and second portions when the valve stem connector is in the closed position.

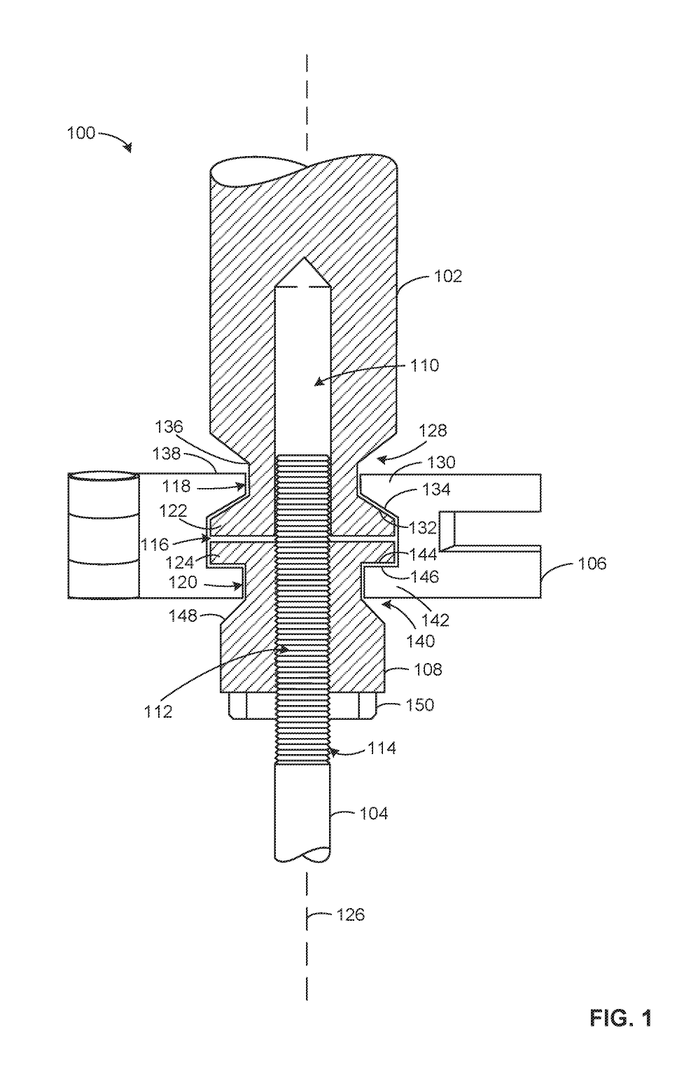

FIG. 1 is an example environment in which an example apparatus 100 described herein may be implemented. FIG. 1 depicts a cross-sectional view of an example apparatus 100 including an actuator stem 102 and a valve stem 104 coupled by an example valve stem connector 106. Additionally, the example valve stem 104 may be threadably coupled to a valve stem adapter 108 and the actuator stem 102. In the illustrated example, the actuator stem 102 and the valve stem adapter 108 include respective bores 110, 112 or holes to threadably engage a threaded portion 114 of the valve stem 104. In the illustrated example, the bore 110 in the actuator stem 102 is a clearance bore to enable the valve stem 104 to pass into the bore 110 without interference. The example bore 112 of the valve stem adapter 108 may be threaded to threadably couple the valve stem 104 to the valve stem adapter 108.

The example valve stem connector 106 described herein is operative to securely couple the actuator stem 102 and the valve stem 104 via the valve stem adapter 108. That is, the valve stem connector 106 prevents separation of the actuator stem 102 and the valve stem 104 when the valve stem connector 106 is coupled to the actuator stem 102 and the valve stem adapter 108. The valve stem adapter 108 is securely coupled to the valve stem 104 to enable the valve stem connector 106 to couple the valve stem 104 to the actuator stem 102. The example valve stem connector 106 and any components of the valve stem connector 106 may be machined, milled, molded, 3-D printed, etc. out of any material, such as metal, suitable to securely couple the valve stem connector 106 to the actuator stem 102 and the valve stem adapter 108.

An internal cavity 116 (e.g., an aperture) is formed by the valve stem connector 106. The cavity 116 has a first opening 118 for the actuator stem 102 and a second opening 120 for the valve stem adapter 108. The cavity 116 is shaped such that a first end 122 of the actuator stem 102 and a first end 124 of the valve stem adapter 108 are substantially joined together (e.g., are unable to separate from each other when the valve stem connector 106 is in place). For example, the first end 122 of the actuator stem 102 and the first end 124 of the valve stem adapter 108 may be in contact to prevent any lost linear motion along a longitudinal axis 126 within the apparatus 100. A diameter of the cavity 116 and/or a diameter of the first opening 118 may be larger (e.g., 0.060 inches larger) than a diameter of the first end 122 and/or a shaft of the actuator stem 102. Similarly, the diameter of the cavity 116 and/or a diameter of the second opening 120 may be larger (e.g., 0.060 inches larger) than a diameter of the first end 124 and/or a shaft of the valve stem adapter 108. The difference in size of the cavity 116 relative to the actuator stem 102 and the valve stem adapter 108 may account for tolerances (e.g., machining tolerances) and/or misalignment between the longitudinal axis 126 of the actuator stem 102, the valve stem 104, and/or the valve stem adapter 108.

The example actuator stem 102 includes a groove 128 at the first end 122 to interact with a corresponding flange 130 of the valve stem connector 106 to prevent the actuator stem 102 from sliding out of the valve stem connector 106. The example groove 128 extends about the entire circumference of the first end 122 of the actuator stem 102. The example groove 128 includes an angled surface 132 corresponding to an angled surface 134 of the flange 130 of the valve stem connector 106. The example flange 130 of the valve stem connector 106 may be disposed within the groove 128 when the valve stem connector 106 is connected to the valve such that the flange 130 does not completely fill the groove 128. That is, there is additional space between an edge 136 of the groove 128 and an edge 138 of the flange 130 to enable the interaction between the groove 128 and the flange 130 to allow for tolerances (e.g., machining tolerances, assembly tolerances, etc.).

The example valve stem adapter 108 may include a groove 140 at the first end 124 to interact with a corresponding flange 142 of the valve stem connector 106 to prevent the valve stem adapter 108 from sliding out of the valve stem connector 106. The groove 140 of the valve stem adapter 108 extends about the entire circumference of the first end 124 of the valve stem adapter 108. The example groove 140 includes a flat surface 144 corresponding to a flat surface 146 of the flange 142 of the valve stem connector 106. The groove 140 may also include an angled surface 148 opposite the flat surface 146 to account for tolerances. The example flange 142 of the valve stem connector 106 may substantially fill the groove 140 of the valve stem adapter 108.

The example valve stem adapter 108 may be securely held in place on the threaded portion 114 of the valve stem 104 by a nut 150 (e.g., a locknut). The nut 150 is operative to prevent the valve stem adapter 108 and the valve stem 104 from becoming decoupled due to vibrations of an actuator. In some examples, the nut 150 may be secured by an adhesive, mechanical staking, or an additional fastener.

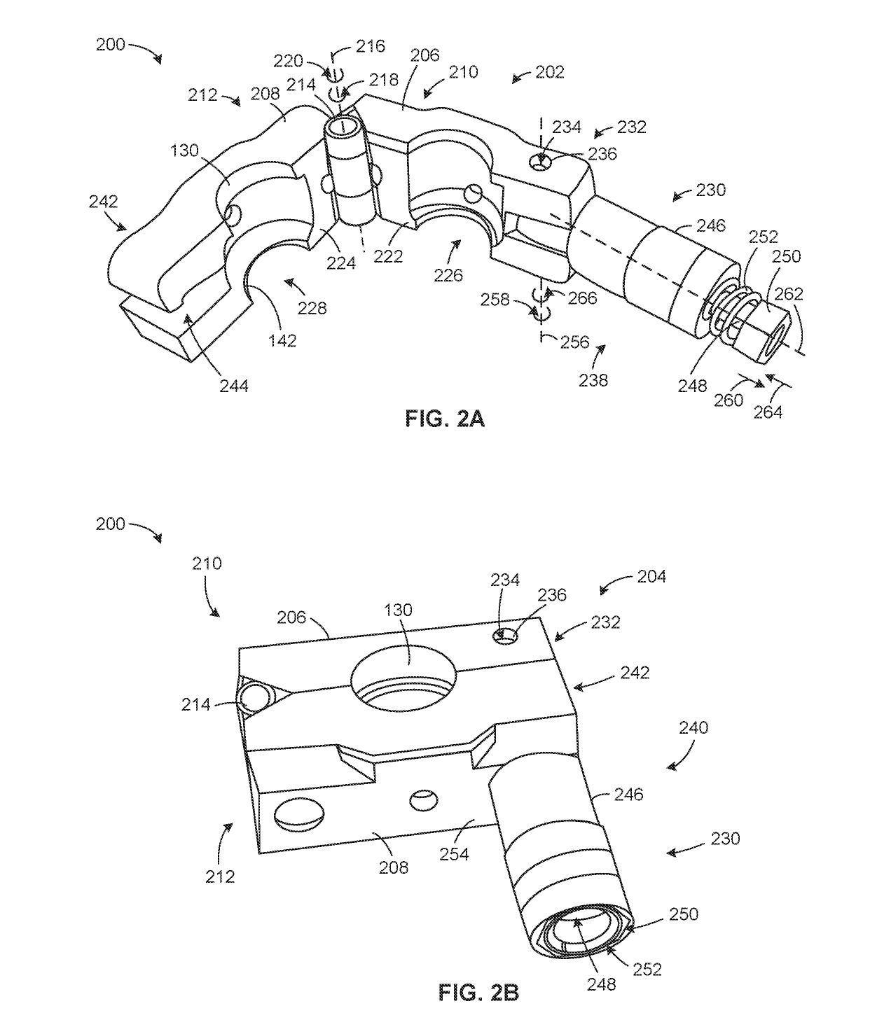

FIGS. 2A and 2B depict an example valve stem connector 200 that may be implemented as the valve stem connector 106 of FIG. 1. FIG. 2A depicts the example valve stem connector 200 in an open position 202 and FIG. 2B depicts the example valve stem connector 200 in a closed position 204. The example valve stem connector 200 may be operative to couple, for example, the actuator stem 102 to the valve stem adapter 108 of FIG. 1. Alternatively, the example valve stem connector 200 may be used to connect any two shafts that may include detents with which the valve stem connector 200 may interface, as described in conjunction with FIG. 1. The example valve stem connector 200 may be in the open position 202 to enable the valve stem connector 200 to be attached to or detached from the example actuator stem 102 and the valve stem adapter 108. When in the closed position 204, the valve stem connector 200 securely couples the example actuator stem 102 and the valve stem adapter 108.

The example valve stem connector 200 includes a first portion 206 and a second portion 208. Each of the first and second portions 206, 208 may be substantially half of the valve stem connector 200. The first and second portions 206, 208 in the illustrated example are operatively coupled at respective first ends 210, 212 of the first and second portions 206, 208 via a hinge 214 (e.g., a flush hinge, a knuckle hinge, a lift-joint butt hinge, a butt hinge, a rising butt hinge, a strap and T hinge, a surface hinge, etc.). The example hinge 214 rotatably couples the first and second portions 206, 208 to enable the first and second portions 206, 208 to rotate relative to one another about an axis 216 of the hinge 214. For example, rotating the first and second portions 206, 208 away from one another (e.g., the first portion 206 rotates in a first direction 218 and the second portion 208 rotates in the second direction 220) moves the valve stem connector 200 toward the open position 202. Rotating the first and second portions 206, 208 towards each other (e.g., the first portion 206 rotates in the second direction 220 and the second portion 208 rotates in the first direction 218) moves the valve stem connector 200 toward the closed position 204.

The first portion 206 includes a first face 222 and the second portion 208 includes a corresponding first face 224. The respective first faces 222, 224 of the first and second portions 206, 208 are in contact when the valve stem connector 200 is in the closed position 204. The first face 222 of the example first portion 206 may include a cutout 226 operative to partially form the cavity 116 of FIG. 1 when the example valve stem connector 200 is in the closed position 204. The cutout 226 of the first portion 206 may form approximately half of the cavity 116. The example first face 224 of the second portion 208 includes a corresponding cutout 228 to partially form (e.g., form half of) the cavity 116. The first and second cutouts 226, 228 may be substantially similar. The example first and second cutouts 226, 228 include flanges (e.g., the flanges 130 and 142) at opposing edges of each of the cutouts 226, 228. The flanges 130, 142 at the edges of the cutouts 226, 228 may form the example first opening 118 and the second opening 120 of the cavity 116, as shown in FIG. 1. In some examples, the cutouts 226, 228 may include indents and/or additional flanges. In some examples, the cutouts 226, 228 may be shaped differently and/or have differently shaped flanges 130, 142.

A fastener 230 may be coupled to a second end 232 of the first portion 206 via a pin 234. The second end 232 of the first portion 206 may include one or more bores 236 in which the pin 234 may be disposed. In some examples, the fastener 230 may instead be coupled via a detent or protrusion of the fastener 230 disposed in the bore(s) 236. The fastener 230 is operative to rotate relative to the second end 232 of the first portion 206 via the interaction between the pin 234 and the bore(s) 236. The example fastener 230 may rotate between a first position 238 (e.g., an unsecured position) depicted in FIG. 2A, and a second position 240 (e.g., a secured position) depicted in FIG. 2B. In the unsecured position 238, the fastener 230 is not in contact with a second end 242 of the second portion 208. In the secured position 240, the fastener 230 may be partially disposed in a groove 244 of the second end 242 of the second portion 208 to secure the first and second portions 206, 208 of the valve stem connector 200 in the closed position 204.

The example fastener 230 includes a collar (e.g., a spring seat collar) 246 secured around a rod 248 via a nut 250. The rod 248 includes a threaded portion to which the nut 250 is threadably coupled. A position of the collar 246 on the rod 248 may be adjusted by moving the nut 250 along the threaded portion of the rod 248. A biasing element 252 (e.g., a spring) may be disposed around the rod 248 between the nut 250 and the collar 246. The biasing element 252 is operative to facilitate securing the fastener 230 when the fastener 230 is moved to the secured position 240. For example, a biasing force of the biasing element 252 holds the collar 246 of the fastener 230 against a second face (e.g., an outer face) of the second portion 208 of the valve stem connector 200 to secure the fastener 230 in the secured position 240. Thus, the second face 254 acts as a stop for the collar 246, and the collar 246 is operative to provide a clamping force to the first and second portions 206, 208 to secure the valve stem connector 200 in the closed position 204. In some examples, moving the nut 250 may affect the tension and/or biasing force of the biasing element 252 and the clamping force of the collar 246.

The example valve stem connector 200 may be attached and removed manually (e.g., without tools, by hand) by a person (e.g., a user, a technician, an operator, etc.). That is, the person may attach and remove the valve stem connector 200 without using any tools because the fastener 230 integrated with the valve stem connector 200 is easily manipulated by hand. When using the example valve stem connector 200, no additional parts are needed to securely couple the actuator stem 102 and the valve stem 104. The first and second portions 206, 208 of the valve stem connector 200 are rotated away from each other by the person to open the valve stem connector 200. To move the valve stem connector 200 from the open position 202 to the closed position 204 to secure the valve stem connector 200 around the example actuator stem 102 and valve stem adapter 108, the first and second portions 206, 208 of the valve stem connector 200 are rotated toward each other by the person. The fastener 230 is then moved from the unsecured position 238 to the secured position 240 by the person. To move the fastener 230 to the secured position 240, the example fastener 230 is rotated about an axis 256 of the pin 234 in a first direction 258 until the fastener 230 is adjacent to the second end 242 of the second portion 208. The collar 246 is moved (e.g., by the person) in a first direction 260 along an axis 262 of the rod 248 until a sufficient length of the rod 248 is exposed to enable the exposed portion of the rod 248 to be positioned in the groove 244 of the second end 242 of the second portion 208 of the valve stem connector 200. The collar 246 may then be released (e.g., by the person) and the biasing force of the biasing element 252 moves the collar 246 in a second direction 264 along the axis 262 of the rod 248 to press the collar 246 against the second face 254 of the second portion 208 to secure the valve stem connector 200 in the closed position 204, thus securely coupling the example actuator stem 102 and valve stem adapter 108.

To remove the valve stem connector 200 from the example actuator stem 102 and valve stem adapter 108, the collar 246 is pulled (e.g., by the person) in the first direction 260 to counteract the biasing force of the biasing element 252 pressing the collar 246 against the second face 254 of the second portion 208. Pulling the collar 246 is the first direction 260 to counteract the biasing force of the biasing element 252 enables the fastener 230 to be rotated in a second direction 266 relative to the axis 256 of the pin 234 until the rod 248 is removed from the groove 244 of the second portion 208. When the fastener 230 is rotated in the second direction 266 far enough that the rod 248 has been removed from the groove 244, the collar 246 is released (e.g., by the person) and the biasing force of the biasing element 252 move the collar 246 in the second direction 264 toward the unsecured position 238 of the collar 246 and/or the fastener 230. The first and second portions 206, 208 of the valve stem connector 200 are rotated away from one another to move the valve stem connector 200 to the open position 202 to remove the valve stem connector 200 from the example actuator stem 102 and valve stem adapter 108, thus decoupling the example actuator stem 102 and valve stem adapter 108.

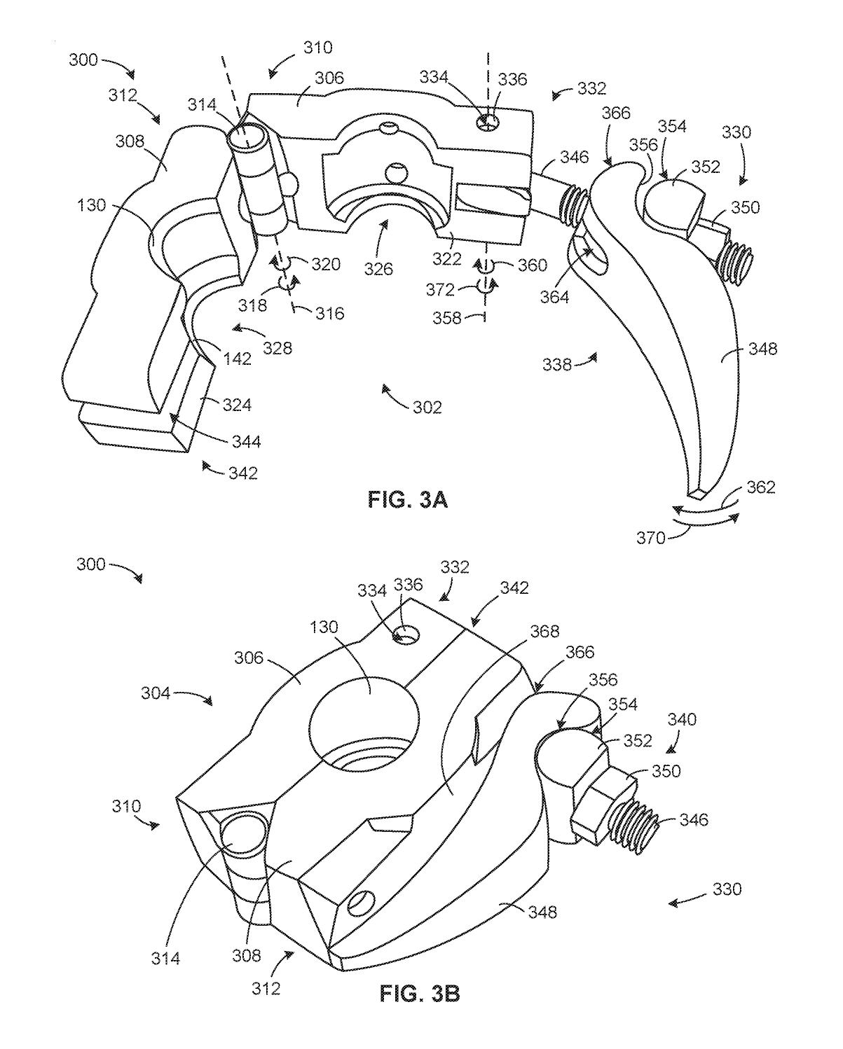

FIGS. 3A and 3B depict another example valve stem connector 300 that may be implemented as the valve stem connector 106 of FIG. 1. FIG. 3A depicts the example valve stem connector 300 in an open position 302 and FIG. 3B depicts the example valve stem connector 300 in a closed position 304. Similar to the example valve stem connector 200 of FIG. 2, the example valve stem connector 300 may be operative to couple, for example, the actuator stem 102 to the valve stem adapter 108 of FIG. 1 when the valve stem connector 300 is in the closed position 304. When the valve stem connector 300 is in the open position 302, the valve stem connector 300 may be attached to or detached from the example actuator stem 102 and/or the example valve stem adapter 108.

The example valve stem connector 300 includes a first portion 306 and a second portion 308. Each of the first and second portions 306, 308 may each be substantially half of the valve stem connector 300. The first and second portions 306, 308 in the illustrated example of FIGS. 3A and 3B are operatively coupled at respective first ends 310, 312 of the first and second portions 306, 308 via a hinge 314. The example hinge 314 rotatably couples the first and second portions 306, 308 to enable the first and second portions 306, 308 to rotate relative to one another about an axis 316 of the hinge 314. For example, rotating the first and second portions 306, 308 away from one another (e.g., the first portion 306 rotates in a first direction 318 and the second portion 308 rotates in the second direction 320) moves the valve stem connector 300 toward the open position 302. Rotating the first and second portions 306, 308 towards each other (e.g., the first portion 306 rotates in the second direction 320 and the second portion 308 rotates in the first direction 318) moves the valve stem connector 300 toward the closed position 304.

The first portion 306 includes a first face 322 and the second portion 308 includes a corresponding first face 324. The respective first faces 322, 324 of the first and second portions 306, 308 are in contact when the valve stem connector 300 is in the closed position 304. The first faces 322, 324 include respective cutouts 326, 328 to form the cavity 116 of FIG. 1 when the example valve stem connector 300 is in the closed position 304. The example cutouts 326, 328 include flanges (e.g., the flanges 130 and 142) at opposing edges of each of the cutouts 326, 328. The example flanges 130, 142 at the edges of the cutouts 326, 328 may form the example first opening 118 and the second opening 120 of the cavity 116, as shown in FIG. 1. In some examples, the cutouts 326, 328 may be shaped differently and/or have different features (e.g., flanges, indents, protrusions, etc.).

A fastener 330 may be coupled to a second end 332 of the first portion 306 via a pin 334. The second end 332 of the first portion 306 may include one or more bores 336 in which the pin 334 may be disposed. In some examples, the fastener 330 may instead be coupled via a detent or protrusion of the fastener 330 disposed in the bore(s) 336. The fastener 330 is operative to rotate relative to the second end 332 of the first portion 306 via the interaction between the pin 334 and the bore(s) 336. The example fastener 330 may rotate between a first position 338 (e.g., an unsecured position) depicted in FIG. 3A, and a second position 340 (e.g., a secured position) depicted in FIG. 3B. In the unsecured position 338, the fastener 330 is not in contact with a second end 342 of the second portion 308. In the secured position 340, the fastener 330 may be partially disposed in a groove 344 of the second end 342 of the second portion 308 to secure the first and second portions 306, 308 of the valve stem connector 300 in the closed position 304.

The example fastener 330 includes a rod 346 operatively coupled to the second end 332 of the first portion 306 via the pin 334. A lever 348 is coupled to the rod 346 to facilitate securing the fastener 330 in the secured position 340. A nut 350 of the example fastener 330 may be operative to adjust a position of the lever 348 on the rod 346 and/or hold the lever 348 on the rod 346 in a designated position. A spacer 352 may be included to enable the lever 348 to rotate and may include a curved surface 354 to interface with a corresponding curved surface 356 of the lever 348. The curved surface 354 of the spacer 352 may facilitate rotation of the lever 348 and/or secure the lever 348 in the secured position 340. The position of the nut 350 and the spacer 352 on the rod 346 may be adjusted based on a thickness of the first and/or the second portions 306, 308, and/or a placement of the bore 336 on the first portion 306.

The example valve stem connector 300 may be attached and removed manually (e.g., without tools, by hand) by the person. That is, the person may attach and remove the valve stem connector 300 without using any tools because the fastener 330 integrated with the valve stem connector 300 is easily manipulated by hand. When using the example valve stem connector 300, no additional parts are needed to securely couple the actuator stem 102 and the valve stem 104. The first and second portions 306, 308 of the valve stem connector 300 are rotated away from each other by the person to open the valve stem connector 300. To attach the valve stem connector 300 (e.g., move the valve stem connector 300 from the open position 302 to the closed position 304 to secure the valve stem connector 300) around the example actuator stem 102 and valve stem adapter 108, the first and second portions 306, 308 of the valve stem connector 300 are rotated toward each other. The fastener 330 is then moved from the unsecured position 338 to the secured position 340 by the person. To move the fastener 330 to the secured position 340, the example fastener 330 is rotated about an axis 358 of the pin 334 in a first direction 360 until the rod 346 of the fastener 330 is in the groove 344 of the second end 342 of the second portion 308 of the valve stem connector 300. The lever 348 may then be rotated in a first direction 362 relative to the rod 346. The lever 348 may include a channel 364 in which the rod 346 is disposed when rotating the lever 348 in the first direction 362. As the lever 348 is rotated in the first direction 362, a cammed surface 366 of the lever 348 interacts with a second face 368 of the second portion 308 of the valve stem connector 300. The second face 368 act as a stop and the cammed surface 366 of the lever 348 applies a clamping force to the first and second portions 306, 308 to secure the valve stem connector 300 in the closed position 304, thus securely coupling the example actuator stem 102 and valve stem adapter 108.

To remove the valve stem connector 300 (e.g., move the valve stem connector 300 from the closed position 304 to the open position 302) from the example actuator stem 102 and valve stem adapter 108, the lever is rotated in a second direction 370 relative to the rod 346. As the lever 348 is rotated in the second direction 370, the cammed surface 366 of the lever 348 moves relative to the second face 368 and decreases the clamping force applied to the valve stem connector 300 by the lever 348. The fastener 330 is rotated in a second direction 372 relative to the axis 358 of the pin 334 until the rod 346 is removed from the groove 344 of the second portion 308. When the fastener 330 is rotated in the second direction 370 far enough that the rod 346 has been removed from the groove 344, the fastener is in the unsecured position 338. The first and second portions 306, 308 of the valve stem connector 300 are rotated away from one another to move the valve stem connector 300 to the open position 302 to remove the valve stem connector 300 from the example actuator stem 102 and valve stem adapter 108, thus decoupling the example actuator stem 102 and valve stem adapter 108.

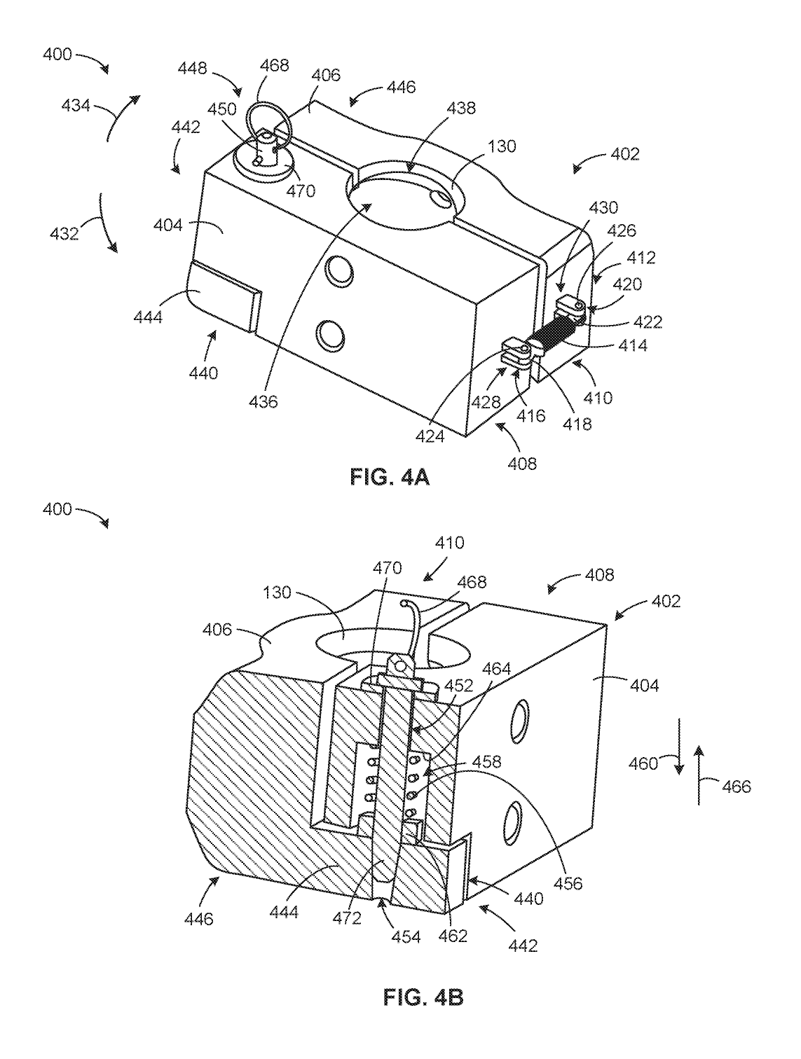

FIGS. 4A and 4B depict another example valve stem connector 400 that may be implemented as the valve stem connector 106 of FIG. 1. FIG. 4A depicts a first perspective of the example valve stem connector 400 in a closed position 402 and FIG. 4B depicts a partial cross-section of a second perspective of the example valve stem connector 400 in the closed position 402. The example valve stem connector 400 may be operative to couple, for example, the actuator stem 102 to the valve stem adapter 108 of FIG. 1 when the valve stem connector 400 is in the closed position 402. When the valve stem connector 400 is in the open position, the valve stem connector 400 may be attached to or detached from the example actuator stem 102 and/or the example valve stem adapter 108. The example valve stem connector of FIGS. 4A and 4B is operative to move to an open position substantially similar to the open positions 202, 302 of respective valve stem connectors 200, 300 of FIGS. 2A and 3A.

The example valve stem connector 400 includes a first portion 404 and a second portion 406. The first and second portions 404, 406 in the illustrated example of FIGS. 4A and 4B are operatively coupled at respective first ends 408, 410 of the first and second portions 404, 406 via a hinge 412. The example hinge 412 rotatably couples the first and second portions 404, 406 to enable the first and second portions 404, 406 to rotate relative to one another. The example hinge 412 may include a spring-type hinge, which may be operative to bias the first and second portions 404, 406 in the closed position 402 of the valve stem connector 400. The spring-type hinge 412 may also be operative to account for misalignment due to, for example, machining and/or assembly tolerances. A spring 414 of the hinge 412 may include a first end 416 having a flange 418 and a second end 420 having a flange 422. Each of the flanges 418, 422 may include a bore through which respective pins 424, 426 may be disposed. The example flanges 418, 422 may be coupled to one or more flanges 428, 430 on each of the first ends 408, 410 of the respective first and second portions 404, 406. The pins 424, 426 are disposed through the bores of the respective flanges 418, 422 of the hinge 412 and bores of the flanges 428, 430 of the respective first ends 408, 410 of the first and second portions 404, 406 to couple the hinge 412 to the example valve stem connector 400. Thus, the respective flanges 428, 430 on the first and second portions 404, 406 are operative to rotate relative to the spring-type hinge 412 about the respective pins 424, 426. Alternatively, another type of hinge to enable rotation of the first and second portions 404, 406 relative to each other may be used. Rotating the first and second portions 404, 406 away from one another (e.g., the first portion 404 rotates in a first direction 432 and the second portion 406 rotates in the second direction 434) moves the valve stem connector 400 toward the open position. Rotating the first and second portions 404, 406 towards each other (e.g., the first portion 404 rotates in the second direction 434 and the second portion 406 rotates in the first direction 432) moves the valve stem connector 400 toward the closed position 402.

The first portion 404 includes a cutout 436 and the second portion 406 includes a corresponding cutout 438. The respective cutouts 436, 438 of the first and second portions 404, 406 form the cavity 116 of FIG. 1 when the example valve stem connector 400 is in the closed position 402. The example cutouts 436, 438 include flanges (e.g., the flanges 130 and 142) at opposing edges of each of the cutouts 436, 438. The example flanges 130, 142 at the edges of the cutouts 436, 438 may form the example first opening 118 and the second opening 120 of the cavity 116, as shown in FIG. 1. In some examples, the cutouts 436, 438 may be shaped differently and/or have different features (e.g., flanges, indents, protrusions, etc.).

In some examples, each of the first and second portions 404, 406 may be substantially half of the valve stem connector 400. In the illustrated example of FIGS. 4A and 4B, the example valve stem connector 400 includes a concavity 440 (e.g., a recess) positioned at a second end 442 of the first portion 404, and a protrusion 444 positioned at a second end 446 of the second portion 406, which corresponds to the concavity 440. The protrusion 444 and the concavity 440 are positioned such that, when in the closed position of the valve stem connector 400, the protrusion 444 is positioned within the concavity 440. Thus, the respective second ends 442, 446 of the first and second portions 404, 406 overlap adjacent to the concavity 440 and the protrusion 444.

A fastener 448 may be coupled to the second end 442 of the first portion 404. The fastener 448 may include a pin 450 at least partially disposed within a bore 452 of the second end 442 of the first portion 404. The pin 450 may be positioned within the bore 452 of the second end 442 such that when the protrusion 444 is disposed within the concavity 440, the pin 450 may be disposed within a bore 454 of the protrusion 444. The interaction between the pin 450 and the bore 454 or groove of the protrusion 444 secures the first and second portions 404, 406 of the example valve stem connector 400 in the closed position 402. The partial cross-sectional view of FIG. 4B depicts the interaction between the pin 450 and the bore 454.

The example fastener 448 may include a biasing element (e.g., a spring) 456 disposed in a cavity 458 of the second end 442 of the first portion 404. The biasing element 456 is positioned around the pin 450 and may be operative to provide a biasing force to urge the pin 450 in a downward direction 460 (e.g., toward the bore of the protrusion 444). The biasing element 456 may be coupled to a spring seat 462 and/an upper surface 464 of the cavity 458. In some examples, the biasing element 456 and/or the spring seat 462 may act as a stop to prevent movement of the pin 450 too far in either the downward direction 460 or an upward direction 466. Alternatively, in some examples, the fastener 448 may not include the biasing element 456. In such examples, the pin 450 may be moved in the downward direction 460 via a force applied by a person, and a disc disposed in the bore 452 may be operative to act as a stop to prevent movement too far in the upward direction 466.

The example fastener 448 further includes a ring 468 positioned at the top of the pin 450 that may be used to pull the pin 450 in the upward direction 466 away from the bore 454 of the protrusion 444. In some examples, the ring 468 may also aid the person in pulling the first and second portions 404, 406 apart from one another toward the open position. The example pin 450 may also include a disc 470 to act as a stop to prevent the pin 450 from moving too far in the downward direction 460 (e.g., maintain the position of the pin 450 within the bore 452 of the second end 442 of the first portion 404) when the person releases the pin 450.

The example valve stem connector 400 may be attached and removed manually (e.g., without tools, by hand) by the person. That is, the person may attach and remove the valve stem connector 400 without using any tools because the fastener 448 integrated with the valve stem connector 400 is easily manipulated by hand. When using the example valve stem connector 400, no additional parts are needed to securely couple the actuator stem 102 and the valve stem 104. The first and second portions 404, 406 of the valve stem connector 400 are rotated away from each other by the person to open the valve stem connector 400. To attach the valve stem connector 400 (e.g., move the valve stem connector 400 from the open position to the closed position 402 to secure the valve stem connector 400) around the example actuator stem 102 and valve stem adapter 108, the first and second portions 404, 406 of the valve stem connector 400 are rotated toward each other. The pin 450 of the fastener 448 is then pulled (e.g., by the person) in the upward direction 466 to enable the protrusion 444 of the second end 446 of the second portion 406 to be positioned within the concavity 440 of the second end 442 of the first portion 404. When the protrusion 444 is fully positioned within the concavity 440, the pin 450 may be released. The pin 450 slides into the bore 454 of the protrusion 444 to secure the first and second portions 404, 406 of the valve stem connector 400 in the closed position 402. In some examples, the pin 450 is not aligned with the bore 454 of the protrusion 444 when the pin 450 is released. In such examples, the second portion 406 is slightly rotated in the first or second direction 432, 434 about the hinge 412 until the pin 450 slides into the bore 454 of the protrusion 444. The bore 454 and/or an end 472 of the pin 450 may be tapered to facilitate alignment of the bore 454 and the pin 450.

To remove the valve stem connector 400 (e.g., move the valve stem connector 400 from the closed position 402 to the open position) from the example actuator stem 102 and valve stem adapter 108, the pin 450 is pulled (e.g., by the person) in the upward direction 466 to release the pin 450 from the bore 454 of the protrusion 444. The first and second portions 404, 406 are moved away from each other (e.g., the first portion 404 is moved in the second direction 434 and the second portion 406 is moved in the first direction 434) toward the open position. When the protrusion 444 is no longer positioned within the concavity 440, the pin 450 may be released and returned to a neutral position.

From the foregoing, it will be appreciated that the above disclosed methods, apparatus and articles of manufacture provide for a valve stem connector that may be quickly connected to and released from an actuator stem and a valve stem without the use of tools.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus comprising:
a valve stem connector including a first portion and a second portion;
a hinge to operatively couple the first and second portions; and
a fastener operatively coupled to the first portion to secure the first and second portions in a closed position.

2. The apparatus as defined in claim 1, wherein the valve stem connector is to be secured in the closed position manually.

3. The apparatus as defined in claim 1, wherein the hinge is operatively coupled to respective first ends of the first and second portions, the hinge to enable the second portion to rotate relative to the first portion.

4. The apparatus as defined in claim 1, wherein the first and second portions form an aperture when the valve stem connector is in the closed position.

5. The apparatus as defined in claim 4, wherein the aperture includes a first opening and a second opening opposite the first opening, the first opening to receive an end of a valve stem and the second opening to receive an end of an actuator stem.

6. The apparatus as defined in claim 1 further including a pin disposed in an aperture of a second end of the first portion, the pin operatively coupled to the fastener to enable the fastener to rotate relative to the first portion.

7. The apparatus as defined in claim 6 further including a groove in a second end of the second portion, the groove to receive a portion of the fastener when the first and second portions of the valve stem connector are in the closed position.

8. The apparatus as defined in claim 7, wherein the fastener includes a stop to contact the second portion adjacent the groove to secure the first and second portions in the closed position.

9. The apparatus as defined in claim 6, wherein the fastener includes a rod, the rod at least partially threaded.

10. The apparatus as defined in claim 9, further including a nut threadably coupled to the rod, the nut to adjust a force applied to the first and second portions by the fastener when the first and second portions are in the closed position.

11. An apparatus comprising a stem connector having a first portion and a second portion, wherein the first and second portions are rotatably coupled via a hinge and secured via a fastener.

12. The apparatus as defined in claim 11 further including a pin to couple the fastener to the first portion, the pin to enable the fastener to rotate relative to the first portion.

13. The apparatus as defined in claim 11 further including a groove disposed in the second portion to receive a portion of the fastener.

14. The apparatus as defined in claim 11, wherein the fastener includes a stop, the stop to clamp the second portion between the first portion and the stop when the stem connector is in a closed position.

15. The apparatus as defined in claim 11 further including an aperture formed by the first and second portions, the aperture to receive a first stem via a first opening and a second stem via a second opening.

16. An apparatus comprising:
means for connecting a first stem and a second stem, the means for connecting including a first portion and a second portion;
means for coupling the first portion to the second portion wherein the means for coupling the first portion to the second portion enables the second portion to rotate relative to the first portion; and
means for securing the means for connecting in a first position, the means for securing operatively coupled to the means for connecting.

17. The apparatus as defined in claim 16, wherein the means for securing is rotatably coupled to the first portion of the means for connecting.

18. The apparatus as defined in claim 16 further including means for receiving the means for securing, the means for receiving disposed in the second portion of the means for connecting.

19. The apparatus as defined in claim 16 further including means for adjusting the means for securing.

20. The apparatus as defined in claim 16 further including means for actuating the means for securing.

21-23. (canceled)

24. A valve stem connector comprising:
a first portion having a first inner face, wherein the first inner face comprises a first cutout that forms a first portion of a cavity;
a second portion having a second inner face, wherein the second inner face comprises a second cutout that forms a second portion of the cavity;
a hinge that rotatably couples the first portion and the second portion; and
a fastener that is rotatably coupled to the first portion, wherein the fastener comprises:
a rod having a threaded portion;
a collar secured around the rod via a nut; and
a biasing element disposed around the rod between the nut and the collar.

25. The valve stem connector of claim 24, wherein the biasing element holds the collar against an outer face of the second portion when the valve stem connector is in a closed position.

26. The valve stem connector of claim 25, wherein the second portion further comprises a groove, and wherein the fastener is partially disposed in the groove when the valve stem connector is in the closed position.
